(19) United States
(12) Patent Application Publication
(10) Pub. No.: US 2006/0062301 A1
(43) Pub. Date: Mar. 23, 2006

(54) Spatial domain pre-processing for computational complexity reduction in advanced video coding (AVC) encoder

(76) Inventor: Brian Sung, Hsinchu (TW)

Correspondence Address: FROMMER LAWRENCE & HAUG LLP, 745 FIFTH AVENUE, NEW YORK, NY, 10151, US

(21) Appl. No.: 11/230,750

(22) Filed: Sep. 20, 2005

(30) Foreign Application Priority Data
Sep. 22, 2004 (TW) 93128762

(51) Int. Cl. H04N 11/04; H04B 1/66; H04N 11/02; H04N 7/12

(52) U.S. Cl. 375/240.13; 375/240.24

(57) ABSTRACT

The present invention relates to a pre-segmentation method for inter-coding and a mode pre-selection method for intra-coding in accordance with standard of advanced video coding. The pre-segmentation method of the present invention is used to pre-segment macro-block for decreasing the times of comparison needed in following inter-coding process in accordance with standard of advanced video coding. The pre-selection method of the present invention is used to pre-select modes from all possible modes so as to reduce the computing complexity in following intra-coding in accordance with standard of advanced video coding.

### FIELD OF THE INVENTION

The present invention relates to a pre-segmentation method for inter-coding and a mode pre-selection method for intra-coding in accordance with standard of advanced video coding. In particular, the present invention relates to a pre-segmentation method used to pre-segment macro-block for decreasing the times of comparison needed in following inter-coding process in accordance with standard of advanced video coding, and relates to a pre-selection method used to pre-select modes from all possible modes so as to reduce the computing complexity in following intra-coding in accordance with standard of advanced video coding.

The above pre-processing could simplify the compression complexity in advanced video coding as well as maintain the image quality.

### PRIOR ART

Recent years, in trend of multimedia and networks, a research in high-speed receiving/transmitting system with high quality video information attracts more attention than ever. Under this trend, a coding specification of visual information is stipulated. A group named “Moving picture expert group (MPEP)” stipulates a standard of MPEG-2 for video application. The success of MPEG-2 could be seen in application of DVD. In 1993 and 1999, a standard of MPEG-4 are presented to the public, which is also called as “MPEG-4 visual” or ISO/IED standard 14496 Part 2. The MPEG-4 comprises regulation in audio coding, system issues and related audio/video communication. In 2000, a specification of so-called “H.264” came out, stipulated by an organization of “Video coding expert group, VCEG”, whose final version published in 2003 by Joint Video Team (JVT). The H.264 becomes one part of MPEG by committee of MPEG and is also called as MPEG4-Part 10 or “Advanced Video Coding”.

In general, “MPEG-4 visual (i.e., ISO/IED standard 14496 Part 2)” is associated with “Advanced Video Coding (i.e., MPEG-4 Part 10)”. However, there is the substantial difference between the two standards. Both of them are relate to compression method for visual information. But, “MPEG-4 visual” employs coding technology and resource in a more flexible way, including the processing of rectangular frame, visual object (visual frame in random shape), and synthetic visual. In contrary, “Advanced Video Coding” emphasizes the efficiency of compression of visual frame, such as higher efficiency in data compression, a more reliable and robust transmission in networking or in visual channel, and application of visual information compression. The difference between “MPEG-4 visual” and “Advanced Video Coding” could be found in a book “H.264 and MPEG-4 Video Compression” published by Wiley Co., written by Iain E. G Richardson, ISBN:0-470-84837-5.

Nevertheless, in spite the visual quality earns people's respect, the computing complexity of “Advance Video Coding” is 200% more than MPEG-2/MPEG-4 visual.

The “Advanced Video Coding”, basically, includes “inter-coding process” as well as “intra-coding process”. Pursuant to the standard of “Advanced Video Coding”, the inter-coding process in its basic configuration is explained as follows.

Frames enter user's eyes in way of progressive or interlaced manner. The frame with resolution 640×480 as an example provides with 640 pixels in each row and 480 pixels in each column is found in FIG. 1a. In visual compression specification, a frame is divided into a plurality of macro blocks. Each macro block is in size of 16×16 (16 pixel×16 pixel). Therefore, referring to FIG. 1a, a frame with resolution 640×480 is divided into 1200 macro blocks in total, in which there are 40 macro blocks in each row and 30 macro blocks in each column. In FIG. 1b, each macro blocks (16×16) is dividable as divided blocks in size of 16×8, 8×16, 8×8, 8×4, 4×8, and 4×4. This division in “Advanced video coding” is called “segmentation”. In general, a divided block in size of 16×16 is referred to as a macro block, a block in size of 8×8 is referred to as a middle square block, and a block in size of 4×4 is referred to as a small square block. In advanced visual coding, the visual compression coding is performed in unit of a macro block. The visual compression coding performs an inter-coding process and an intra coding process so as to decide how each macro block is to be divided. The inter-coding process comprises sub-processes of “motion vector estimation”, “dynamic vector compensation”, “bit rate/distortion optimal”. The dynamic vector compensation is designed to utilize as few bits as possible to represent a macro block. For example, if a macro block (x,y) shown in an object frame such as frame(i) is represented by one of macro block (x-μx, y-μy) shown in previous frame, such as frame (i-n), the vector (μx, μy) is the only information needed for coding in dynamic vector, so that fewer bits are needed in coding. There are 259 different ways to have a single 16×16 macro block divided into sub-blocks. FIG. 1c and FIG. 1d are two examples of divided blocks. For a 8×8 middle square block, there are four possible segmenting ways as shown in FIG. 1e, from upper to bottom including one 8×8 middle square block, two 8×4 blocks, two 4×8 blocks, and four 4×4 little square blocks. Each divided sub-block has to compare all blocks with the same size shown in previous frame so as to find optimal “Sum of Absolute Errors (SAE)” as well as “bit rate”. Bit rate represents how many bits needed for representing the divided block. A diagram as example in relation of bit rate and optimal “sum of absolute errors” is depicted in curve as shown in FIG. 1f. After designer chooses a weighted linear function J=f(R) according to his/her desire, which is a line as shown in FIG. 1f, the intersected point of the curve and the line decides what value in R (bit rate) and value in D (SAE value) is optimal. Thus, the divided block with optimal R and D is chosen as the best divided block. For example, in FIG. 1e, the first segmenting way as one 8×8 block provides with mv(μx1, μy1) and SAE1, the second segmenting way as two 8×4 divided blocks provides with mv(μx21, μy21) and SAE21 as well as mv(˜x22, μy22) and SAE22, the third segmenting way as two 4×8 sub-blocks provides with mv(μx31, μy31) and SAE31 as well as mv(μx32, μy32) and SAE32, and the fourth segmenting way as four 4×4 sub-blocks provides with mv(μx41, μy41) and SAE41, mv(μx42, μy42) and SAE42, mv(μx43, μy43) and SAE43 as well as mv(μx44, μy44) and SAE44. Now, assuming each dynamic vector requires two bytes, we presume the first segmentation with SAE1=100, bit-rate=2, the second segmentation with SAE21+SAE22=75, bit-rate=4, the third segmentation with SAE31+SAE32=65, bit-rate=4, and the fourth segmentation with SAE41+SAE42+SAE43+SAE44=30, bit rate=8. The result with above values in depicted in FIG. 1f. Designer chooses function J=F(R) according to his/ her experience or desire. The intersection points decides that a segmentation with two 4×8 divided-blocks is the best segmentation, so that the 8×8 block is divided into two 4×8 sub-block.

The above computing in inter-coding process is found complex. For example, in the first segmentation shown in FIG. 1e, which is one 8×8 divided block, the values mv(μx1, μy1) and SAE1 are obtained by comparing all 8×8 divided blocks shown in previous frame. Thus, the comparison with all 8×8 divided blocks shown in previous frame will really take time. Therefore, if a block can be pre-segmented, the times of comparison will reduce extraordinary. The present invention is to provide a pre-segmentation method for decreasing the times of comparison needed in proceeding inter-coding process pursuant to the standard of advanced video coding.

Secondly, the intra-coding method in advanced visual coding is explained as follows.

In the intra-coding method, on basis of the row and column neighboring to the target block, pixels in target block are predicted. There are 4 prediction modes for a marco block (16×16), including mode 0, 1, 2 and 4, as shown in FIG. 1g and FIG. 1h. There are 9 prediction modes for small square block (4×4) as shown in FIG. 1i and FIG. 1j. After these possible modes are performed, the mode with optical “Sum of Absolute Errors” is chosen as a result.

Therefore, if a pre-processing can pre-select some modes, it will greatly accelerate the computation.

### SUMMARY OF THE INVENTION

The present invention is a pre-processing in the advanced video coding so as to accelerate computation in visual process.

The present invention relates to a pre-processing of the advanced video coding, comprising a pre-segmentation method for inter-coding and a mode pre-selection method for intra-coding. In particular, the present invention relates to a pre-segmentation method used to pre-segment macro-block for decreasing the times of comparison needed in following inter-coding process in accordance with standard of advanced video coding, and relates to a pre-selection method used to pre-select modes from all possible modes so as to reduce the computing complexity in following intra-coding in accordance with standard of advanced video coding.

In consideration of inter-coding in the advanced video coding, the comparison with divided blocks with same size as target blocks in previous frame will really take time. The present invention provides a pre-segmentation method which is processed prior to the inter-coding so as to decrease the times of comparison needed in inter-coding process pursuant to the standard of advanced video coding.

In addition, the pre-processing of the present invention in regard of intra-coding eliminates the unnecessary modes in intra-coding so as to accelerate the computing speed.

### A BRIEF DESCRIPTION OF DRAWINGS

FIG. 1a to FIG. 1j are illustration of prior advanced video coding;

FIG. 2 is a flowchart representing the pre-segmentation of the present invention;

FIG. 3 is a view showing the similarity test in accordance to one embodiment of the present invention;

FIG. 4a and FIG. 4b are illustrations showing pre-segmentation method of the present invention;

FIG. 5a and FIG. 5b are illustrations showing pre-segmentation method of the present invention;

FIG. 6 is a view showing an intra-coding for a macro block (16×16) in accordance with the present invention;

FIG. 7 is a view showing an intra-coding for a small square block (4×4) in accordance with the present invention;

FIG. 8 shows a view of pre-segmentation in accordance with the present invention; and

FIG. 9 shows final view after the process of optimal bit rate/distortion.

### PREFERRED EMBODIMENT

In following description, the detailed is set for people to understand the present invention, but not to limit the scope of the present invention. The present invention can be implemented without some of the detailed for person who has a common knowledge in the field. The following description is explained as embodiments by referring to the drawings. The present invention is not limited to the embodiments. The modification of the embodiments should be deemed within the scope of the present invention, if the modification is made on basis of the spirit of the present invention.

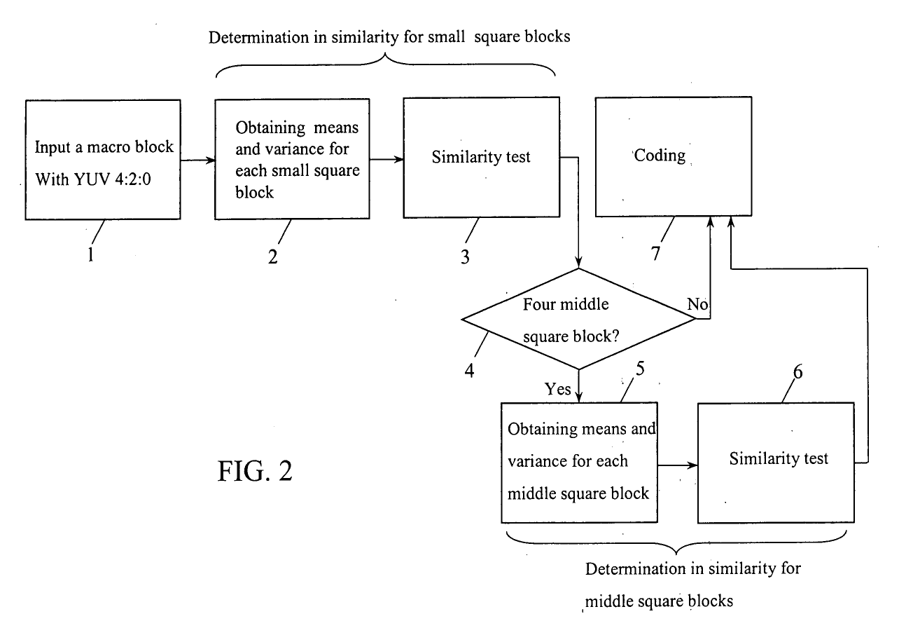

The embodiment of pre-segmentation method of the present invention is explained as follows. The flowchart of the pre-segmentation of the present invention is found in FIG. 2. In process 1, by YUV, in sample of 4:2:0, a macro block (16×16) as a target macro block on basis of CCIR601 standard is inputted. The macro block (16×16) is divided into four 8×8 middle square blocks, and further each 8×8 middle square block is divided into 4×4 small square blocks. Four 4×4 small square blocks, within the scope of one 8×8 middle square, are decided whether they are merged to a larger blocks or not by processing a similarity test for small square block, including means sub-process and variance sub-process 2 as well as similarity test process 3. Equation 1 represents the formulation of means sub-process, and Equation 2 represents the formulation of variance sub-process.

$$\text{Equation 1:}$$

$$M = \frac{1}{N} {\sum }_{i = 1}^{N} {X}_{i} ,$$

wherein N is sampling number.

$$\text{Equation 2:}$$

$$Var = \frac{1}{N} {\sum }_{i = 1}^{N} {X}_{i}^{2} - {M}^{2}$$

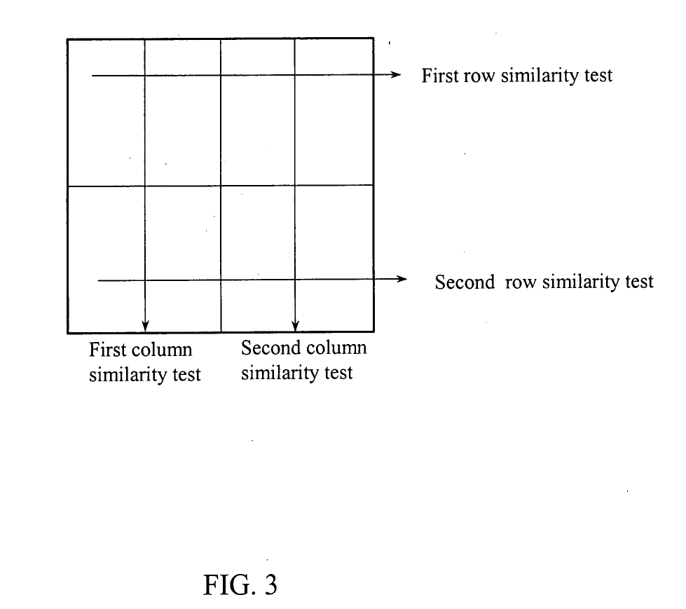

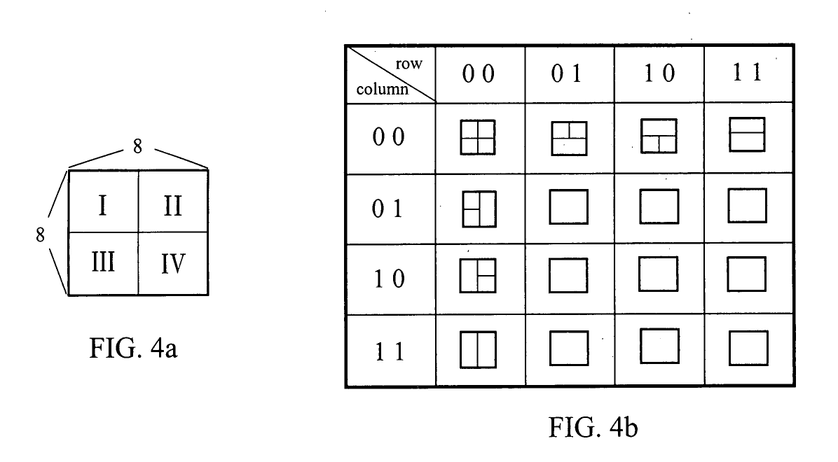

In similarity test process 3, neighboring 4×4 blocks compares M and Var with each other, as shown in FIG. 3 and FIG. 4.
|m1−m2|≦ε1, Equation 3:
wherein m1, m2 is M value for each neighboring blocks, respectively. ε1 is pre-determined value decided by designer.
|σ₁²−σ₂²|≦ε2, Equation 4:
wherein σ₁², σ₂² are Var value for each neighboring blocks, respectively. ε2 is pre-determined value decided by designer.

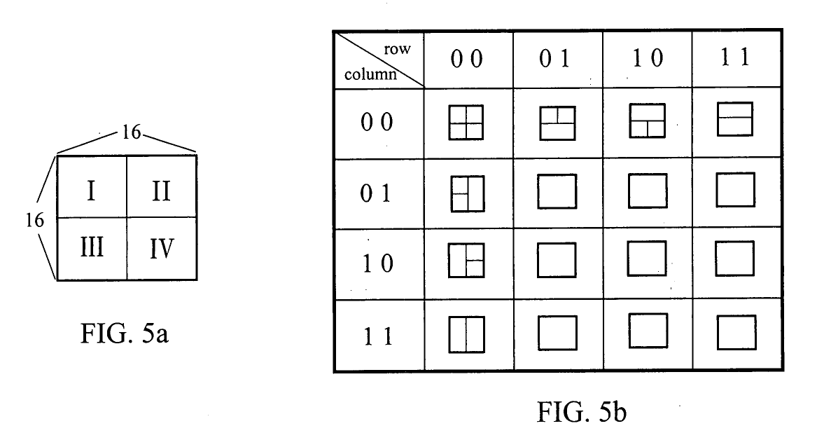

If and only if the emergence in process 2 and process 3 decides four middle square blocks (8×8) (decided in process 4), i.e., sixteen 4×4 small square blocks emerged into four 8×8 middle square blocks, the following processes are needed, including process 4, 5 and 6. Otherwise, no further mergence is need. Four 8×8 middle square blocks, within the scope of one 16×16 macro square, are decided to be merged or not by processing a similarity test for middle square block, including means sub-process and variance sub-process 5 as well as similarity test process 6 in accordance to the same equation 1 to 4. Illustrations for better understanding are shown in FIG. 4a, FIG. 4b, FIG. 5a and FIG. 5b. FIG. 4a and FIG. 4b represent processes 2 and 3 in FIG. 2. In FIG. 4a, each middle square block (8×8) is divided into 4 portion as shown in reference I, II, III and IV. The possible emergence circumstances in accordance with the above are found in FIG. 4b. FIG. 5a and FIG. 5b represent processes 5 and 6 in FIG. 2. In FIG. 5a, each macro block (16×16) is divided into 4 portion as shown in reference I, II, III and IV. The possible emergence circumstance in accordance with the above are found in FIG. 5b.

The pre-segmentation of the present invention is explained as above.

The pre-selection method of the present invention will be explained as following.

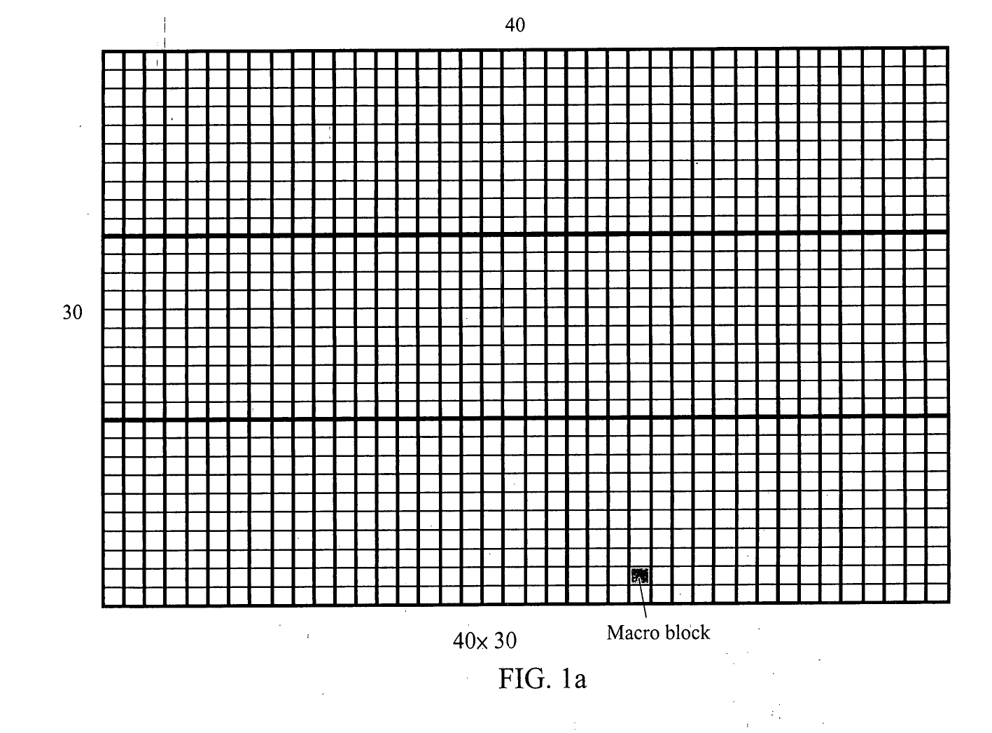

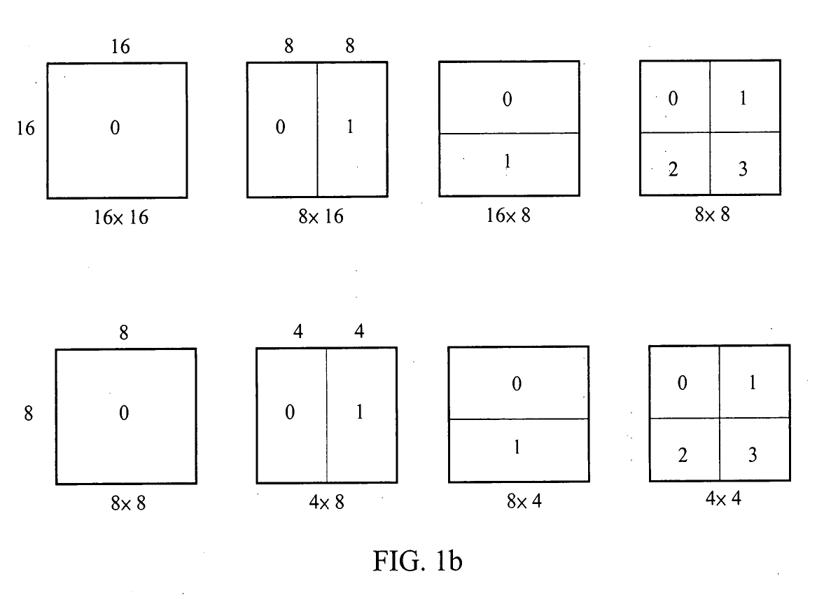

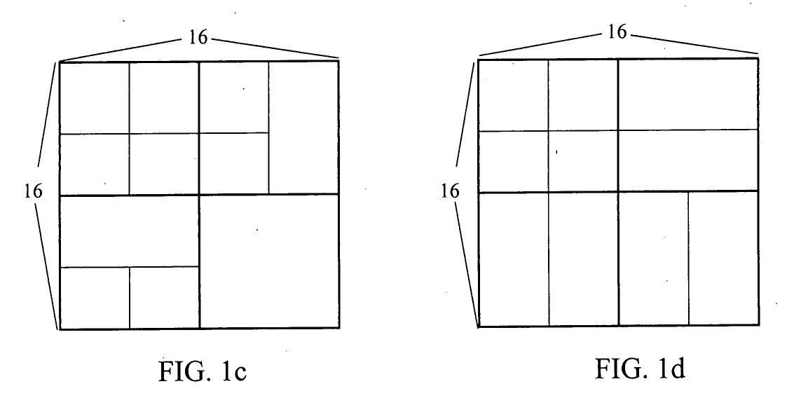

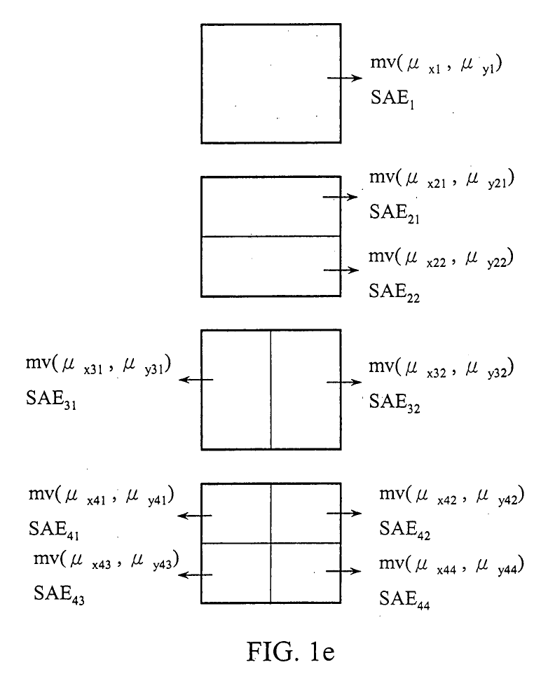

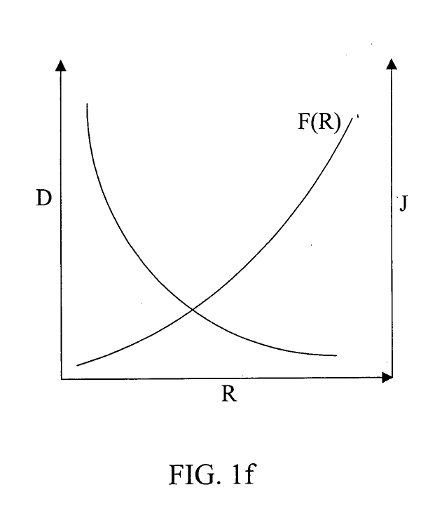

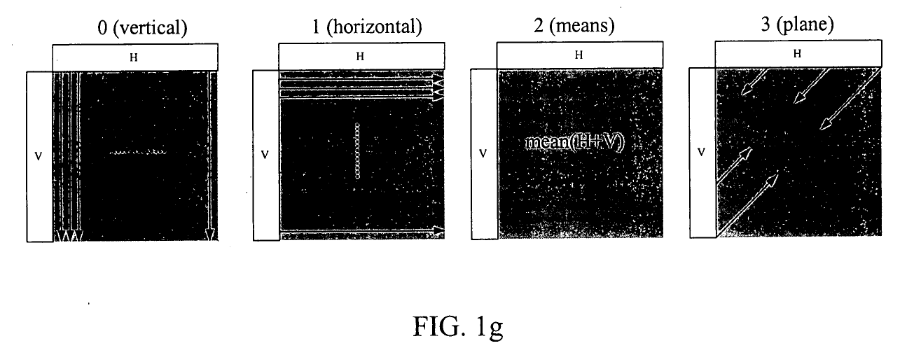

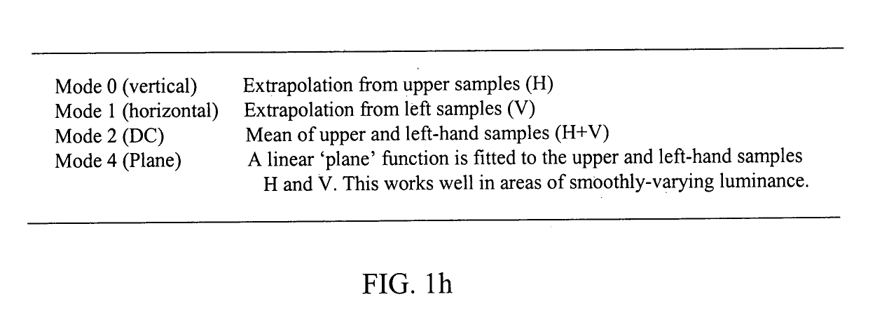

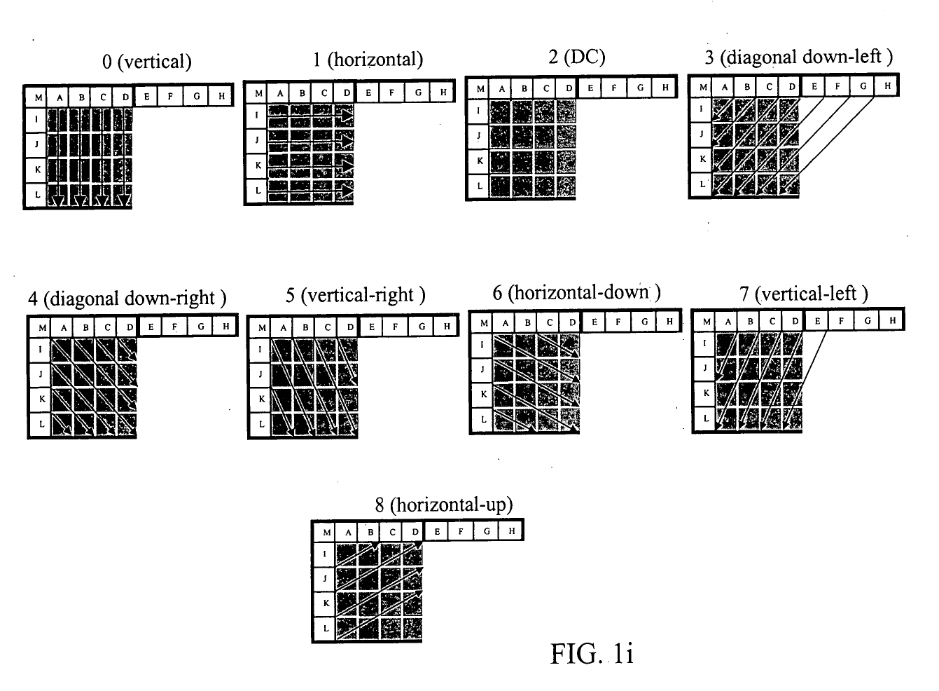

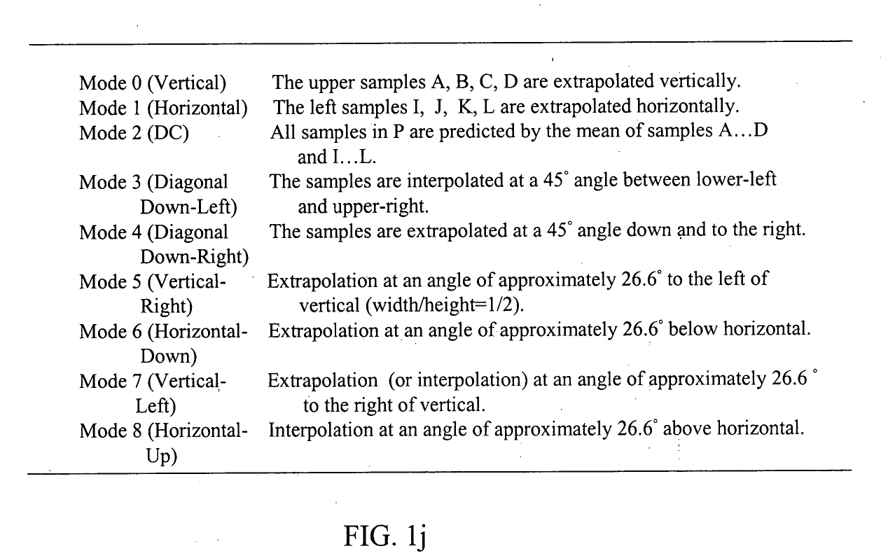

The intra-coding method in the advanced video coding chooses the best mode from 9 modes for 4×4 small square block as shown in FIG. 1i and from 4 modes for 16×16 macro block, as shown in FIG. 1g. The pre-selection method of the present invention excludes the unnecessary modes from 9 possible modes for 4×4 small square block and from 4 possible modes for 16×16 macro block.

The pre-selection method of intra-coding for macro block of the present invention is explained as follows.

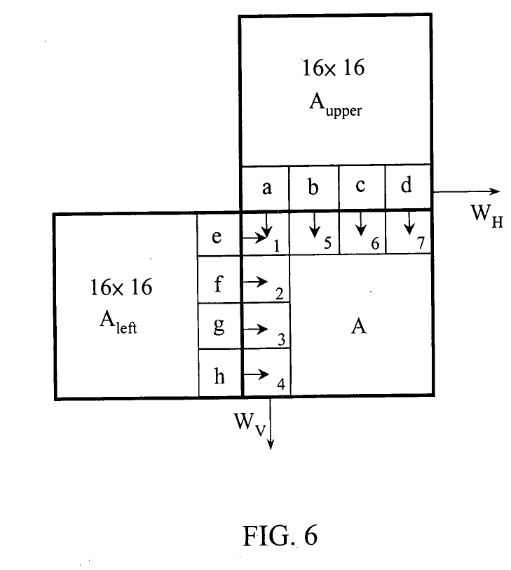

As shown in FIG. 6, seven small square blocks (4×4) within a macro block A (16×16) are picked up as shown as with their reference numerals 1 to 7. Four small square blocks (4×4) 1 to 4 compare with, through similarity test, respective small square blocks (4×4) e, f, g and h of Aleft, which is a macro block (16×16) neighboring to the macro block A. In the same way, four small square blocks (4×4) 1, 5, 6 and 7 compare with, through similarity test, respective small square blocks (4×4) a,b,c,d of Aupper, which is a macro block (16×16) neighboring to the macro block A. A weight value Wi is set to 1 if the similarity test is found within a predetermined value. Otherwise, it is set to 0. The sum of Wi in a row is represented as

$$WH = {\sum }_{i} {W}_{i} ,$$

where i=1,5,6,7 and the sum of Wi in a column is represented as

$$Wv = {\sum }_{i} {W}_{i} ,$$

where i=1,2,3,4.

When WH=Wv, mode 4, which performs linear prediction in row and in column direction, is chosen.

When WH>Wv, mode 0, which performs linear prediction from upper to bottom direction, is chosen.

When WH<Wv, mode 1, which performs linear prediction from left to right direction, is chosen.

Please be noted that mode 2 is a default mode for intra-coding of macro block. Only when SAE value of mode 0, 1 and 4 is less then SAE value of mode 2, the comparison of WH and Wv is performed.

Next, the pre-selection method of intra-coding for small square block is explained as follows.

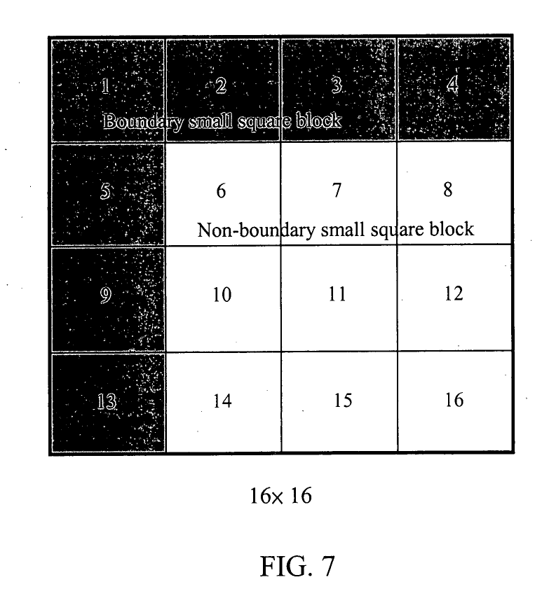

A macro block in divided in sixteen small square blocks as shown in FIG. 7, in which blocks 1, 2, 3, 4, 5, 9 13 are called as boundary small square blocks, the other small square blocks 6, 7, 8, 10, 11, 12, 14, 15 and 16 are called as non-boundary small square blocks. The boundary small square blocks are performed all prediction process of nine modes. The non-neighboring blocks performs following process.

A weight Wleft is set 1 if the similarity difference between the target block and its left block, such as between block 6 and 5, is found less than a predetermined value. In the same way, a weight Wtop is set 1 if the similarity difference between the target block and its upper block, such as between block 6 and 2, is found less than a predetermined value, otherwise it is set 0. The conditions are as follows.

In default or if Wtop=Wleft=0, it performs mode 2 (means (DC) mode).

If Wtop=1, Wleft=0, it performs the best mode with smallest SAE value from mode 0, 3 7.

If Wtop=0, Wleft=1, it performs the best mode with smallest SAE value from mode 1, 8.

If Wtop=Wleft=1, it performs the best mode with smallest SAE value from mode 4, 5 and 6.

In other words, if a non-boundary small square block is found no similarity with upper block and with left block, then it performs mode 2. If a non-boundary small square block is found similarity with upper block but no similarity with left block, it performs the best mode with smallest SAE value from mode 1, 8. If a non-neighboring block is no found similarity with upper block but found similarity with left block, it performs the best mode with smallest SAE value from mode 4, 5 and 6.

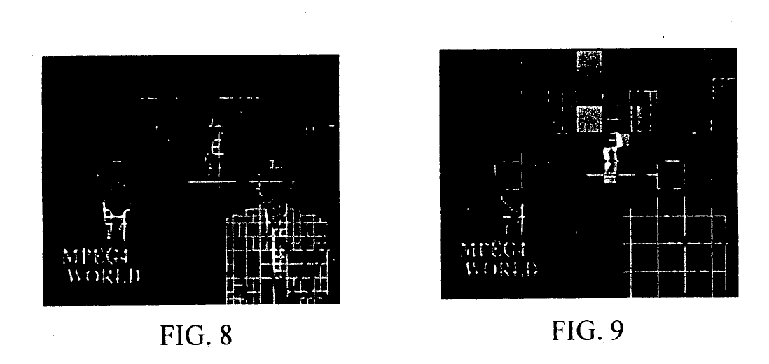

Please be noted that the similarity tests in the above are not limited to Equation 1 and Equation 2 as shown in the above. Any testing method used in testing two random number is usable. The pre-segmentation of the present invention is found in FIG. 8. In left black portion, because of the similarity, it is divided as 16×16 macro block. In FIG. 9, it shows the final result after optimal of bit rate and distortion. The gray area in FIG. 9 represents the portion processed by intra-coding.

Table 1 shows the experimental data regarding “Peak signal to noise ratio” for target block in comparison of boundary merging technology and not boundary merging technology. The input signal is Video Quality Experts Group (VQEG) with resolution 720×480 processed in rate of 30 frames per second coded by IBPBP . . . . In addition, TM5 flow rate control algorithm is applied to further precisely control the simulation. From the experimental data, the image quality of the present invention is not deteriorated. In other words, the image quality obtained by present invention is maintained.

TABLE 1

| | Applying the | Without applying | |
|---|---|---|---|
| | pre-processing of | the pre-processing | |
| | the present | of the present | |
| In comparison of | invention under the | invention under the | |
| PSNR in | transmission rate of | transmission rate of | |
| unit of dB | 1.5 Mbps | 1.5 Mbps | Difference |
| Canoe | 36.81 | 36.92 | −0.13 |
| Cheer | 31.83 | 32.16 | −0.33 |
| Ferry | 35.64 | 35.88 | −0.24 |
| Flower | 33.56 | 33.68 | −0.12 |
| Football | 37.22 | 37.31 | −0.09 |
| Hook | 38.90 | 39.04 | −0.14 |
| Mobile | 33.03 | 33.18 | −0.15 |

The comparison in time saving is shown in Table 2, on basis of determination of dynamic segment, estimation search of dynamic vector and pre-selection mode method in intra-coding. In column of the “determination of dynamic segment”, it represents the time saving after processing of optimal bit rate/distortion. The column in “estimation search of dynamic vector” represents the time saving on grounds that it is not necessary to perform all modes. In column of “mode selection method for 4×4 block”, it represents the time saving after the similarity test is performed.

TABLE 2

| | | | Mode selection |
|---|---|---|---|
| | Determination of | Estimation search of | method for 4 × 4 |
| | dynamic segment | dynamic vector | block |
| Time saving | 52% | 40% | 53% |

1. A pre-segmentation method of a macro block in the advance video coding, wherein each macro block comprising four 8×8 middle square blocks, and each 8×8 middle square block comprising four 4×4 small square blocks; the method comprising:
a similarity test step of small square blocks for deciding whether the neighboring small square blocks are merged or not;
only if four middle square blocks are obtained in the preceding step, a similarity test step of middle square blocks is performed to decide whether the neighboring middle square blocks are merged or not; and
a coding step, which codes the segmented macro block in accordance with the above result.

2. A pre-segmentation method of claim 1, wherein the similarity test step of small square blocks obtains means and variance for each one of small square block, so as to find similarity between the neighboring small square blocks.

3. A pre-segmentation method of claim 1, wherein the similarity test step of middle square blocks obtains means and variance for each one of middle square block, so as to find similarity between the neighboring middle square blocks.

4. A pre-segmentation method of claim 2, wherein means of small square blocks represents the means in brightness.

5. A pre-segmentation method of claim 2, wherein means of small square blocks represents the means in brightness and chromaticity.

6. A pre-segmentation method of claim 3, wherein means of middle square blocks represents the means in brightness.

7. A pre-segmentation method of claim 2, wherein means of middle square blocks represents the means in brightness and chromaticity.

8. A pre-segmentation method of claim 2, wherein variance(var) is obtained by equation of
$$Var = \frac{1}{N} {\sum }_{i = 1}^{N} {X}_{i}^{2} - {M}^{2} ,$$
wherein Xi represents brightness of each pixel in the small square block, and M represents the means of each pixel in the small square block.

9. A pre-segmentation method of claim 3, wherein variance(var) is obtained by equation of
$$Var = \frac{1}{N} {\sum }_{i = 1}^{N} {X}_{i}^{2} - {M}^{2} ,$$
wherein Xi represents brightness of each pixel in the middle square block, and M represents the means of each pixel in the middle square block.

10. A pre-segmentation method of claim 2, wherein the similarity test step of small square blocks determines the similarity in scope of a middle square block in consideration of each row and each column of the middle square block.

11. A pre-segmentation method of claim 10, wherein the eight circumstances thereof include (1) if the first row, second row, first column, second column are found not in similarity, four small square blocks (4×4) are obtained; (2) if only the second row are in similarity, it obtains two upper small square blocks (4×4) and one bottom 4×8 block; (3) if only the first row is in similarity, it obtains two bottom small square blocks (4×4) and one upper 4×8 block; (4) if only the first row and the second row are in similarity, it obtains two 4×8 blocks; (5) if only the second column is in similarity, it obtains two left small square blocks (4×4) and one right 8×4 block; (6) if only the first column is in similarity, it obtains two right small square blocks (4×4) and one left 8×4 block; (7) if only the first column and second column are in similarity, it obtains two 8×4 blocks; and (8) if the first row, second row, first column, second column are all in similarity, it obtains one middle square block.

12. A pre-segmentation method of claim 3, wherein a similarity test step of middle square blocks determines the similarity in scope of a macro block in consideration of each row and each column of the macro block.

13. A pre-segmentation method of claim 12, wherein the eight circumstances thereof includes (1) if the first row, second row, first column, second column are found not in similarity, it obtains four middle square blocks (8×8); (2) if only the second row are in similarity, it obtains two upper middle blocks (8×8) and one bottom 8×16 block; (3) if only the first row is in similarity, it obtains two bottom middle blocks (8×8) and one upper 8×16 block; (4) if only the first row and the second row are in similarity, it obtains two 8×16 blocks; (5) if only the second column is in similarity, it obtains two left middle blocks (8×8) and one right 1 6×8 block; (6) if only the first column is in similarity, it obtains two right middle blocks (8×8) and one left 1 6×8 block; (7) if only the first column and second column are in similarity, it obtains two 16×8 blocks; and (8) if the first row, second row, first column, second column are all in similarity, it obtains one macro block.

14. A pre-segmentation method of a macro block in the advanced video coding, wherein each macro block comprising four middle square blocks, each middle square block comprising four small square blocks named as a first target block, a second target block, a third target block, and a fourth target block in sequence from upper left, upper right, bottom left and bottom right;
a step for obtaining means of pixels as a first value and variance of pixels as a second value in accordance with brightness;
a first merging step, which performs a similarity test for comparing similarity between neighboring small square blocks within the scope of each middle square block, wherein if the difference of first value between the neighboring small square blocks is less than a first predetermined value and the difference of second value between the neighboring small square blocks is less than a second predetermined value, then it performs mergence, otherwise it does not perform mergence;
only if four middle square blocks are obtained in previous step, a second merging step, which performs a similarity test for comparing similarity between neighboring middle square blocks within the scope of each macro block; and coding the obtained blocks.

15. A mode pre-selection method of intra-coding in the advanced video coding for macro blocks, comprising:
a step for selecting small square blocks in upper-most row and left-most column of the macro block and their neighboring small square blocks in neighboring two macro blocks;
a step for accumulate similarity of upper most row of the macro block as compared with their neighboring small square blocks in the neighboring macro blocks to obtain a value of row similarity, and for accumulate similarity of left most row of the macro block as compared with their neighboring small square blocks in the neighboring macro blocks to obtain a value of column similarity,
wherein if the value of row similarity is equal to the value of column similarity, the mode 4 is selected as mode performed in intra-coding,
if the value of row similarity is larger than the value of column similarity, the mode 0 is selected as mode performed in intra-coding, and
if the value of row similarity is less than the value of column similarity, the mode 1 is selected as mode performed in intra-coding.

16. A mode pre-selection method of intra-coding in the advanced video coding for macro blocks, comprising:
a step for selecting small square blocks in upper-most row and left-most column of the macro block and their neighboring small square blocks in neighboring two macro blocks;
a step for accumulate similarity of upper most row of the macro block as compared with their neighboring small square blocks in the neighboring macro blocks to obtain a value of row similarity, and for accumulate similarity of left most row of the macro block as compared with their neighboring small square blocks in the neighboring macro blocks to obtain a value of column similarity, in which the similarity is performed in accordance the means and variance values,
wherein if the value of row similarity is equal to the value of column similarity, the mode 4 is selected as mode performed in intra-coding,
if the value of row similarity is larger than the value of column similarity, the mode 0 is selected as mode performed in intra-coding, and
if the value of row similarity is less than the value of column similarity, the mode 1 is selected as mode performed in intra-coding.

17. A mode pre-selection method of intra-coding in the advanced video coding for small square blocks, comprising:
a step for selecting small square blocks in upper-most row and left-most column of the macro block as boundary blocks, the other blocks in the macro block as non-boundary blocks;
a step for performing nine modes for boundary blocks to choose the best boundary blocks with smallest SAE value;
a step of similarity test for non-boundary block, which performs similarity test between the small square block and its upper small square block so as to decide the similarity in column, and performs similarity test between the small square block and its left small square block so as to decide the similarity in row,
wherein if it is found no similarity in column and no similarity in row, a mode 2 is selected as mode for performing intra-coding in the advanced video coding,
if it is found similarity in column and no similarity in row, modes 0, 3 and 7 are selected as modes for performing intra-coding in the advanced video coding,
if it is found no similarity in column and similarity in row, modes 1, 8 are selected as mode for performing intra-coding in the advanced video coding,
if it is found similarity in column and similarity in row, modes 4, 5 and 6 are selected as modes for performing intra-coding in the advanced video coding.

18. A mode pre-selection method of intra-coding in the advanced video coding for small square blocks, comprising:
a step for selecting small square blocks in upper-most row and left-most column of the macro block as boundary blocks, the other blocks in the macro block as non-boundary blocks;
a step for performing nine modes for boundary blocks to choose the best boundary blocks with smallest SAE value;
a step of similarity test for non-boundary block, which performs similarity test between the small square block and its upper small square block so as to decide the similarity in column, and performs similarity test between the small square block and its left small square block so as to decide the similarity in row, in which the similarity is performed in accordance the means and variance values,
wherein if it is found no similarity in column and no similarity in row, a mode 2 is selected as mode for performing intra-coding in the advanced video coding,
if it is found similarity in column and no similarity in row, modes 0, 3 and 7 are selected as modes for performing intra-coding in the advanced video coding,
if it is found no similarity in column and similarity in row, modes 1, 8 are selected as mode for performing intra-coding in the advanced video coding, and
if it is found similarity in column and similarity in row, modes 4, 5 and 6 are selected as modes for performing intra-coding in the advanced video coding.
